(19) United States
(12) Patent Application Publication
(10) Pub. No.: US 2021/0131136 A1
(43) Pub. Date: May 6, 2021

(54) Multimedia Grave Marker Assembly

(71) Applicant: Isaac King, Washington, PA (US)

(72) Inventor: Isaac King, Washington, PA (US)

(21) Appl. No.: 16/670,429

(22) Filed: Oct. 31, 2019

(51) Int. Cl. E04H 13/00; H04N 21/414; H04N 21/462; H04N 5/44; H04N 5/765

(52) U.S. Cl. CPC E04H 13/001; E04H 13/003; H04N 5/765; H04N 21/4622; H04N 5/4401; H04N 21/41415

(57) ABSTRACT

A multimedia grave marker assembly for enhancing the experience of observing a gravesite includes a base that is positionable on the ground at a gravesite. A grave marker is coupled to and extends upwardly from the base such that the grave marker is associated with the gravesite. A touch screen is coupled to the grave marker and the touch screen displaying indicia comprising words and images associated with a deceased person buried at the gravesite. In this way the touch screen enhances mourning the deceased person. A speaker is coupled to the grave marker to emit audible sound that is associated with the deceased person.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to grave marker devices and more particularly pertains to a new grave marker device for enhancing the experience of observing a gravesite.

### (2) Description of Related Art

Including information disclosed under 37 CFR 1.97 and 1.98.

The prior art relates to grave marker devices.

### BRIEF SUMMARY OF THE INVENTION

An embodiment of the disclosure meets the needs presented above by generally comprising a base that is positionable on the ground at a gravesite. A grave marker is coupled to and extends upwardly from the base such that the grave marker is associated with the gravesite. A touch screen is coupled to the grave marker and the touch screen displaying indicia comprising words and images associated with a deceased person buried at the gravesite. In this way the touch screen enhances mourning the deceased person. A speaker is coupled to the grave marker to emit audible sound outwardly therefrom that is associated with the deceased person.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a multimedia grave marker assembly according to an embodiment of the disclosure.

FIG. 2 is a front view of an embodiment of the disclosure.

FIG. 3 is a back phantom view of an embodiment of the disclosure.

FIG. 4 is a phantom perspective view of an alternative embodiment of the disclosure showing a grave marker being recessed into a vault.

FIG. 5 is a phantom perspective view of an alternative embodiment of the disclosure showing a grave marker being deployed from a vault.

FIG. 6 is a perspective phantom view of an alternative embodiment of the disclosure showing a grave marker being recessed into a base.

FIG. 7 is a perspective phantom view of an alternative embodiment of the disclosure showing a grave marker being deployed from a base.

### DETAILED DESCRIPTION OF THE INVENTION

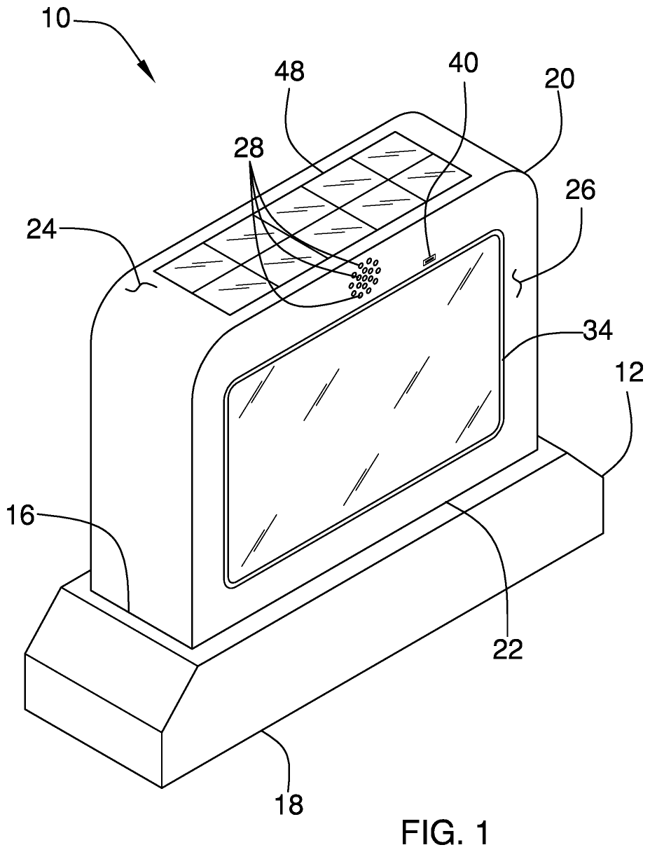

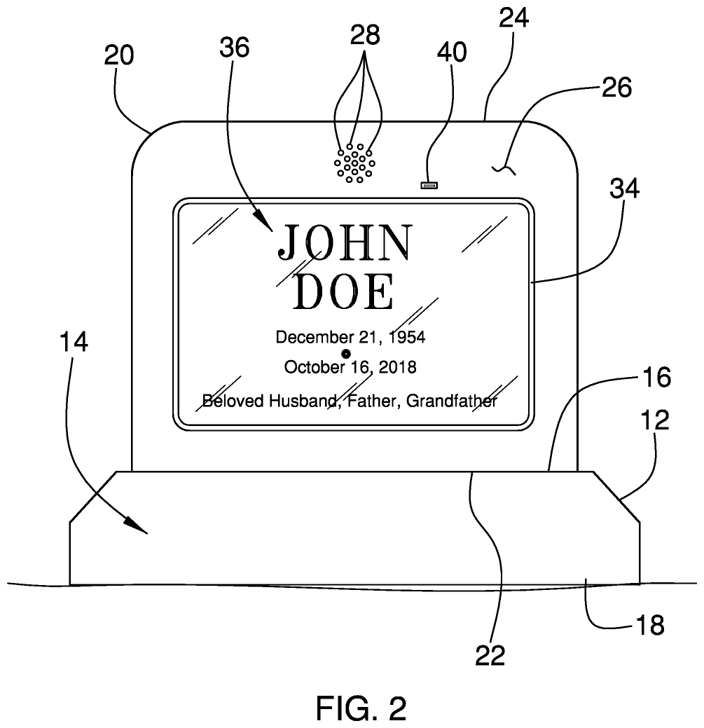

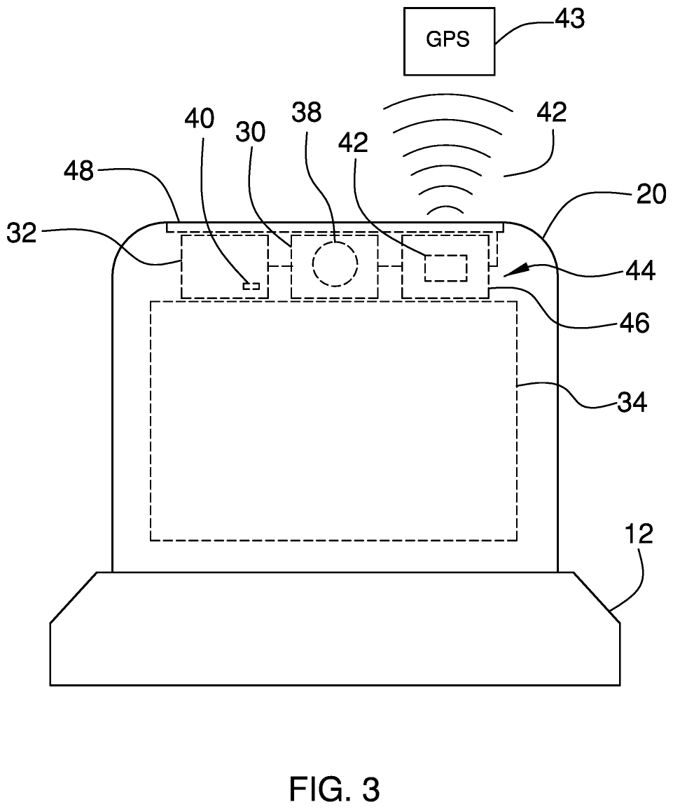

With reference now to the drawings, and in particular to FIGS. 1 through 7 thereof, a new grave marker device embodying the principles and concepts of an embodiment of the disclosure and generally designated by the reference numeral 10 will be described.

As best illustrated in FIGS. 1 through 7, the multimedia grave marker assembly 10 generally comprises a base 12 is positionable on the ground at a gravesite 14. The base 12 has a top side 16 and a bottom side 18. A grave marker 20 is coupled to and extends upwardly from the base 12 such that the grave marker 20 is associated with the gravesite 14. The grave marker 20 has a bottom surface 22, a top surface 24 and a forward surface 26. The bottom surface 22 is attached to the top side 16 of the base 12 having the forward surface 26 being directed toward the gravesite 14. In this way the forward surface 26 is directed toward a person who is observing the gravesite 14.

The forward surface 26 has a plurality of speaker openings 28 each extending into an interior of the grave marker 20, and the grave marker 20 is hollow. A control circuit 30 is coupled to the grave marker 20 and an electronic memory 32 is coupled to the grave marker 20. The electronic memory 32 is electrically coupled to the control circuit 30 and the electronic memory 32 stores a database 12 comprising digital imagery and digital audio. The electronic memory 32 may comprise RAM, a hard disk drive or any other type of electronic data storage.

A touch screen 34 is provided and the touch screen 34 is coupled to the grave marker 20. The touch screen 34 displays indicia 36 comprising words and images associated with a deceased person buried at the gravesite 14. In this way the touch screen 34 enhances the process of mourning the deceased person. The touch screen 34 is electrically coupled to the control circuit 30 such that the touch screen 34 receives the digital imagery from the electronic memory 32. Additionally, the touch screen 34 is positioned on the forward surface 26 of the grave marker 20. The touch screen 34 may comprise an LCD touch screen or any other type of electronic display that responds to touch.

A speaker 38 is coupled to the grave marker 20 to emit audible sounds outwardly therefrom. The speaker 38 is electrically coupled to the control circuit 30 such that the speaker 38 receives the digital audio from the electronic memory 32. The speaker 38 may comprise an electronic speaker of any conventional design and the speaker 38 is aligned with each of the speaker openings 28 in the forward surface 26 of the grave marker 20. A data port 40 is recessed into the grave marker 20 to receive a data cord of an electronic device. The data port 40 is electrically coupled to the control circuit 30 for downloading data into the electronic memory 32. The data port 40 may comprise, but not be limited to, a usb port, a firewire port, a micro usb port or any other type of electronic data port.

A transceiver 42 is coupled to the grave marker and the transceiver 42 is electrically coupled to the control circuit. The transceiver 42 is in electrical communication with a global positioning system 43 for determining the physical location of the gravesite 14. In this way the transceiver 42 can communicate the physical location of the gravesite 14 to a personal electronic device for guiding the user to the gravesite 14.

The transceiver 42 may comprise a radio frequency transceiver or the like and the personal electronic device may be a smart phone or the like.

A power supply 44 is coupled to the grave marker 20 and the power supply 44 is electrically coupled to the control circuit 30. The power supply 44 comprises at least one battery 46 that is positioned in the grave marker 20. The at least one battery 46 is electrically coupled to the control circuit 30. The power supply 44 also includes a solar panel 48 that is coupled to the top surface 24 of the grave marker 20 to be exposed to sunlight. The solar panel 48 is electrically coupled to the at least one battery 46 for charging the at least one battery 46.

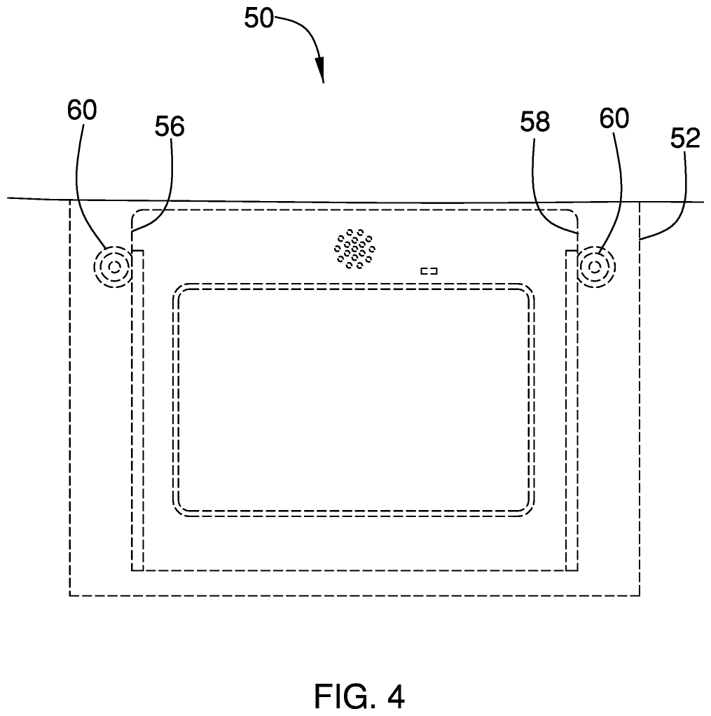

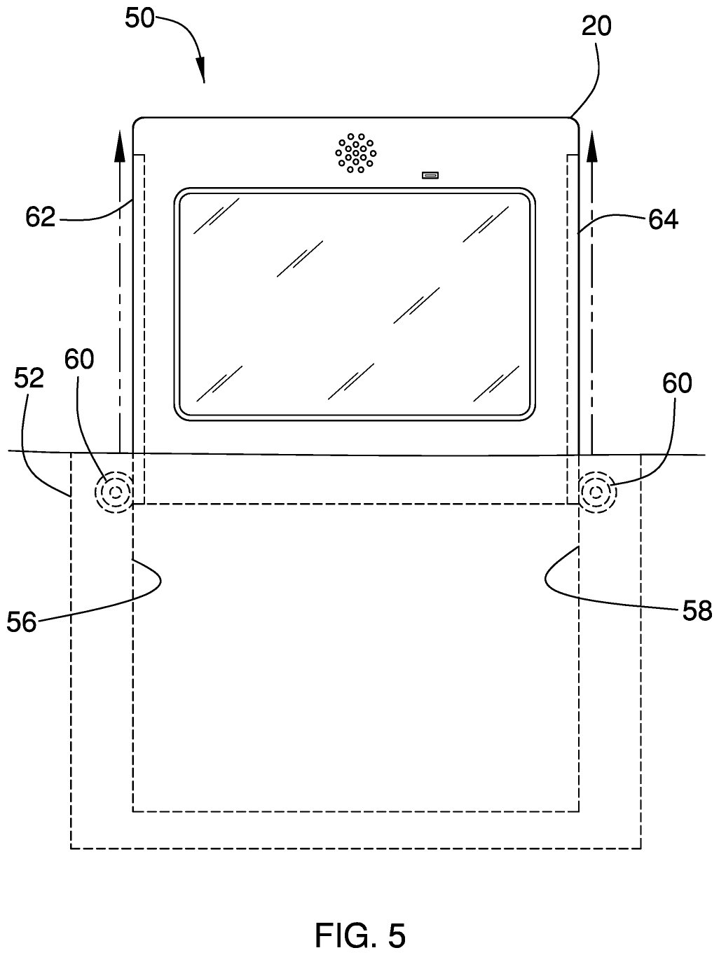

In an alternative embodiment 50 as is most clearly shown in FIGS. 4 and 5, a vault 52 is provided that has a top end 54, a first lateral wall 56 and a second lateral wall 58. The top end 54 is open and the vault 52 is buried at the gravesite 14 having the top end 54 being exposed. A pair of actuators 60 is each coupled to a respective one of the first lateral wall 56 and the second lateral wall 58 of the vault 52, and each of the actuators 60 is positioned within the vault 52. Each of the actuators 60 may include, but not be limited to, an electric motor and tracks, a linear actuator, a hydraulic piston or any other type of electro-mechanical actuator.

Continuing in the alternative embodiment 50, the grave marker 20 is movably positioned in the vault 52. Each of the actuators 60 engages a respective one of a first lateral surface 62 and a second lateral surface 64 of the grave marker 20. Additionally, each of the actuators 60 is turned on in a first condition for raising the grave marker 20 into a deployed position having the grave marker 20 extending outwardly through the top end 54 of the vault 52. Each of the actuators 60 is turned on in a second condition for lowering the grave marker 20 into a stored position having the grave marker 20 being retracted into the vault 52.

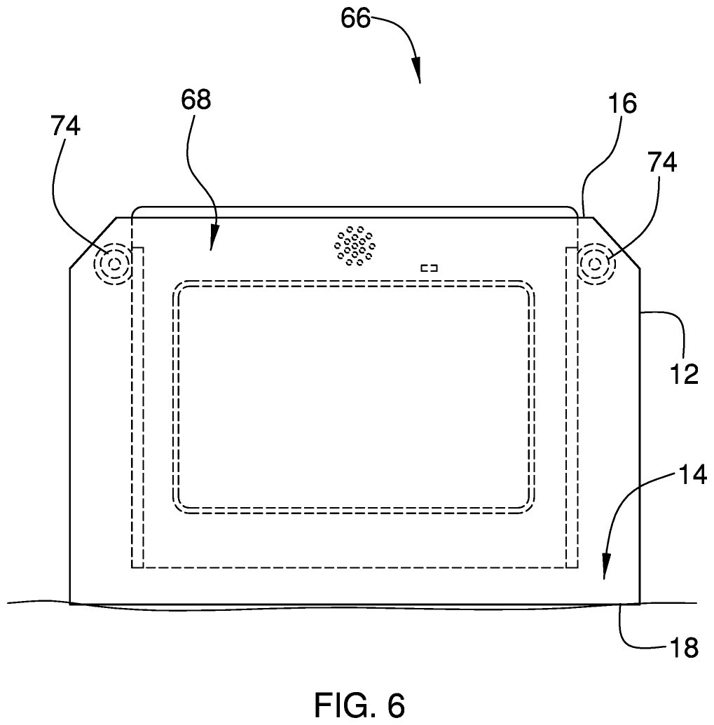

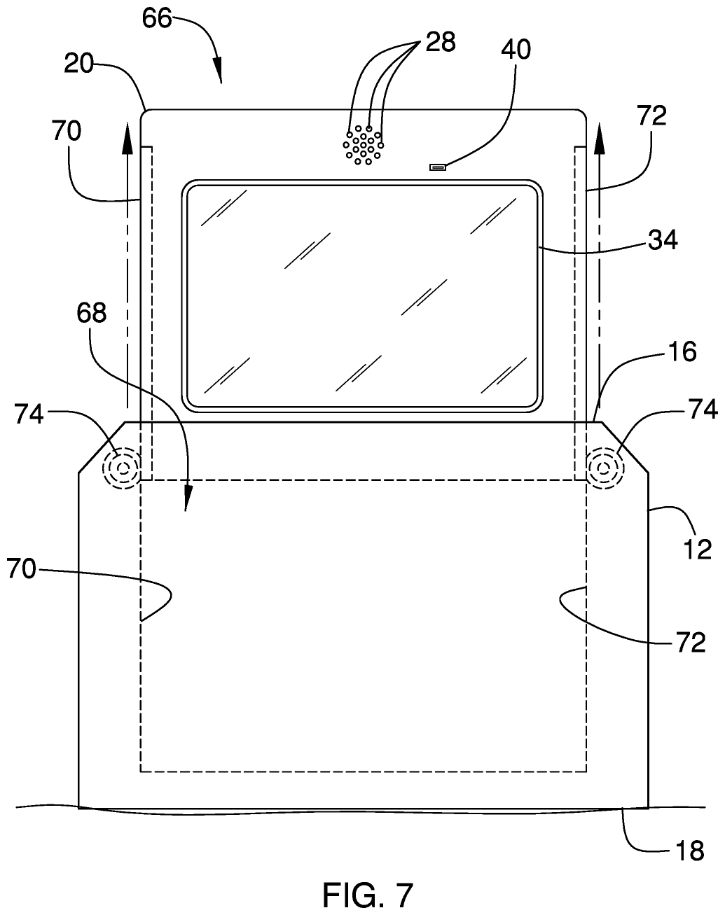

In an alternative embodiment 66 as is most clearly shown in FIGS. 6 and 7, the base 12 has a height that is at least equal to a height of the grave marker 20. The top side 16 of the base 12 has a well 68 extending toward the bottom side 18 of the base 12 and the grave marker 20 is movably positioned in the well 68. The well 68 has a first lateral bounding surface 70 and a second lateral bounding surface 72.

The alternative embodiment 66 in FIGS. 6 and 7 includes a pair of actuators 74 that is each coupled to a respective one of the first lateral bounding surface 70 and the second lateral bounding surface 72 of the well 68. Each of the actuators 74 engages a respective one of the first lateral surface 70 and the second lateral surface 72 of the grave marker 20. Each of the actuators 74 is turned on in a first condition for raising the grave marker 20 into a deployed position having the grave marker 20 extending outwardly through the top side 16 of the base 12. Conversely, each of the actuators 74 is turned on in a second condition for lowering the grave marker 20 into a stored position having the grave marker 20 being retracted into the well 68.

In use, the digital imagery and the digital audio are downloaded into the electronic memory 32 through the data port 40. Thus, the touch screen 34 displays selected imagery and words associated with the deceased. Additionally, the speaker 38 emits the digital audio that is associated with the deceased. In this way a person that is observing the gravesite 14 can see imagery on the touch screen 34 as well as hear the audio from the speaker 38. The person observing the gravesite 14 can also manipulate the touch screen 34 for accessing menus or additional information that is stored in the electronic memory 32.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A multimedia grave marker assembly being configured to touch screen indicia and project audio related to a deceased person at a gravesite, said multimedia grave marker assembly comprising:
a base being positionable on the ground at the gravesite, said base having a top side and a height, said top side of said base having a well extending toward said a bottom side of said base, said well having a first lateral bounding surface and a second lateral bounding surface;
a grave marker being coupled to and extending upwardly from said base wherein said grave marker is configured to be associated with the gravesite, said height of said base being at least equal to a height of said grave marker, said grave marker being movably positioned in said well;
a pair of actuators, each of said actuators being coupled to a respective one of said first lateral bounding surface and said second lateral bounding surface of said well, each of said actuators engaging a respective one of a first lateral surface and a second lateral surface of said grave marker, each of said actuators being turned on in a first condition for raising said grave marker into a deployed position having said grave marker extending outwardly through said top side of said base, each of said actuators being turned on in a second condition for lowering said grave marker into a stored position having said grave marker being retracted into said well;
a touch screen being coupled to said grave marker, said touch screen displaying indicia comprising words and images associated with the deceased person buried at the gravesite wherein said touch screen is configured for mourning the deceased person; and
a speaker being coupled to said grave marker wherein said speaker is configured to emit audible sounds outwardly therefrom that are associated with the deceased person.

2. The multimedia grave marker assembly according to claim 1, wherein
said grave marker has a bottom surface, a top surface and a forward surface, said forward surface being directed toward the gravesite, said front surface having a plurality of speaker openings each extending into an interior of said grave marker, said grave marker being hollow.

3. The multimedia grave marker assembly according to claim 2, further comprising:
a control circuit being coupled to said grave marker; and
an electronic memory being coupled to said grave marker, said electronic memory being electrically coupled to said control circuit, said electronic memory storing a database comprising digital imagery and digital audio.

4. The multimedia grave marker assembly according to claim 3, wherein said touch screen is electrically coupled to said control circuit such that said touch screen receives said digital imagery from said electronic memory, said touch screen being positioned on said forward surface of said grave marker.

5. The multimedia grave marker assembly according to claim 3, wherein said speaker is electrically coupled to said control circuit such that said speaker receives said digital audio from said electronic memory.

6. The multimedia grave marker assembly according to claim 3, further comprising a data port being recessed into said grave marker wherein said data port is configured to receive a data cord of an electronic device, said data port being electrically coupled to said control circuit for downloading data into said electronic memory.

7. The multimedia grave marker assembly according to claim 3, further comprising a power supply being coupled to said grave market, said power supply being electrically coupled to said control circuit, said power supply comprising:
at least one battery being positioned in said grave marker, said at least one battery being electrically coupled to said control circuit; and
a solar panel being coupled to said top surface of said grave marker wherein said solar panel is configured to be exposed to sunlight, said solar panel being electrically coupled to said at least one battery for charging said at least one battery.

8. The multimedia grave marker assembly according to claim 3, further comprising a transceiver being coupled to said grave marker, said transceiver being electrically coupled to said control circuit, said transceiver being in electrical communication with a global positioning system for determining the physical location of said grave site wherein said transceiver is configured to communicate the physical location of said gravesite to a personal electronic device for guiding the user to said gravesite.

9. A multimedia grave marker assembly being configured to touch screen indicia and project audio related to a deceased person at a gravesite, said multimedia grave marker assembly comprising:
a base being positionable on the ground at the gravesite, said base having a top side and a bottom side, said base having a height, said top side of said base having a well extending toward said bottom side of said base, said well having a first lateral bounding surface and a second lateral bounding surface;
a grave marker being coupled to said base wherein said grave marker is configured to be associated with the gravesite, said height of said base being at least equal to a height of said grave marker, said grave marker being movably positioned in said well, said grave marker having a bottom surface, a top surface and a forward surface, said forward surface being directed toward the gravesite, said front surface having a plurality of speaker openings each extending into an interior of said grave marker, said grave marker being hollow:
a pair of actuators, each of said actuators being coupled to a respective one of said first lateral bounding surface and said second lateral bounding surface of said well, each of said actuators engaging a respective one of a first lateral surface and a second lateral surface of said grave marker, each of said actuators being turned on in a first condition for raising said grave marker into a deployed position having said grave marker extending outwardly through said top side of said base, each of said actuators being turned on in a second condition for lowering said grave marker into a stored position having said grave marker being retracted into said well:
a control circuit being coupled to said grave marker;
an electronic memory being coupled to said grave marker, said electronic memory being electrically coupled to said control circuit, said electronic memory storing a database comprising digital imagery and digital audio;
a touch screen being coupled to said grave marker, said touch screen displaying indicia comprising words and images associated with the deceased person buried at the gravesite wherein said touch screen is configured for mourning the deceased person, said touch screen being electrically coupled to said control circuit such that said touch screen receives said digital imagery from said electronic memory, said touch screen being positioned on said forward surface of said grave marker:;
a speaker being coupled to said grave marker wherein said speaker is configured to emit audible sounds outwardly therefrom that are associated with the deceased person, said speaker being electrically coupled to said control circuit such that said speaker receives said digital audio from said electronic memory;
a data port being recessed into said grave marker wherein said data port is configured to receive a data cord of an electronic device, said data port being electrically coupled to said control circuit for downloading data into said electronic memory;
a transceiver being coupled to said grave marker, said transceiver being electrically coupled to said control circuit, said transceiver being in electrical communication with a global positioning system for determining the physical location of said grave site wherein said transceiver is configured to communicate the physical location of said gravesite to a personal electronic device for guiding the user to said gravesite; and
a power supply being coupled to said grave marker, said power supply being electrically coupled to said control circuit, said power supply comprising:
at least one battery being positioned in said grave marker, said at least one battery being electrically coupled to said control circuit; and
a solar panel being coupled to said top surface of said grave marker wherein said solar panel is configured to be exposed to sunlight, said solar panel being electrically coupled to said at least one battery for charging said at least one battery.

10. (canceled)

11. (canceled)

12. (canceled)

13. (canceled)

14. (canceled)

15. (canceled)
